(19) United States
(12) Patent Application Publication
(10) Pub. No.: US 2009/0053960 A1
(43) Pub. Date: Feb. 26, 2009

(54) Roof Liner for Vehicle and Manufacturing Method of Same

(75) Inventors: Mary Dovell, Woodstock, OH (US); Masato Ishibashi, Tochigi (JP); Yoshihiro Asano, Kanagawa (JP)

Correspondence Address: Capitol IP, PLLC, 113 S. Columbus St., Suite 311, Alexandria, VA, 22314, US

(73) Assignees: Honda Motor Co., Ltd., Tokyo (JP); Kasai Kogyo Co., Ltd., Kanagawa (JP)

(21) Appl. No.: 11/844,178

(22) Filed: Aug. 23, 2007

(51) Int. Cl. D04H 1/00; B29C 51/00; B32B 27/12; B32B 5/26

(52) U.S. Cl. 442/334; 264/322; 264/41; 442/381; 442/394

(57) ABSTRACT

The present disclosure is directed to a roof lining for a vehicle and a manufacturing method thereof, and in particular, to the roof lining for a vehicle using a composite material having basalt fibers mixed into a thermoplastic resin as a substrate. The resulting roof lining can be lightweight, have enhanced sound absorbency and increased heat insulating properties. Due to the use of basalt fibers, which do not coat incinerator walls like glass fibers do, the roof lining is more easily recycled.

### BACKGROUND

1. Field of the Invention

The present disclosure relates to a roof lining for a vehicle and a manufacturing method thereof, and in particular, to the roof lining for a vehicle using a composite resin material having basalt fibers mixed into a thermoplastic resin as a substrate. The resulting roof lining can achieve desired properties including lightweight, enhanced sound absorbency, stiffness and increased heat insulating properties. With the use of basalt fibers, the roof lining is more easily recycled.

2. Description of the Related Art

A roof lining having good sound absorbency and heat insulating properties is normally mounted on an interior face side of a roof panel of a vehicle. As shown in FIG. 11, a typical roof lining has a surface skin layer 3 having pleasing tactile properties and appearance attached to a front face side of a substrate 2 having shape retaining properties and sufficient stiffness for mounting on the roof panel. The substrate can also have a multilayer lamination structure having a backside nonwoven fabric 4 attached thereto for increasing the sound absorbency of the roof lining.

A polypropylene (“PP”) resin mixed with glass fibers is typically used for the substrate 2 as shown in FIG. 12. The material can have a compounding ratio of PP resin 45 weight % to glass fibers 55 weight %. A hot-melt film 2a, for instance, a polyamide resin film, for increasing enhancing adhesiveness to the facing 3 is laminated on the front face side of the substrate 2 while an air-impermeable layer 2b consisting of a polyamide resin film is laminated on the backside of the substrate 2. Thus, a configuration for preventing dust and the like from adhering to the front face side of the roof lining 1 is obtained.

For the surface skin layer 3, a nonwoven fabric having a relatively heavy weight of 200 g/m2, or a cloth having a weight of 130 g/m2 can be used. As for the backside nonwoven fabric 4, a polyester nonwoven fabric of the weight of 15 g/m2 and elongation of about 50% is be used. The configuration of a conventional roof lining is described in detail in Japanese Patent Application Publication No. 2004-74951.

Thus, in the case of using a polyolefin resin with glass fibers as the material for the roof lining 2, a roof lining having the requisite stiffness and high sound absorbency along with good dimension stability is obtained. On the other hand, there is the problem of recycling the roof lining. Upon recycling of the glass fiber-containing roof lining by incineration, the glass fibers typically melt, or partially melt, and form an undesirable residue in the incinerator. The removal of the glassy residue from the furnace walls results in maintenance requiring many man-hours.

Thus, there is a problem that the roof lining composed of a polyolefin resin mixed with glass fibers cannot be easily recycled.

### SUMMARY OF THE PRESENT DISCLOSURE

The present disclosure is directed to a method for producing a roof lining for a vehicle by forming a web including basalt fibers and a resin composition, heating the web to a temperature sufficient to melt the resin composition, and pressing the web into a blank with a first thickness. The blank is then heated to a temperature sufficient to melt the resin composition, and press formed to form the roof lining.

The forming of the web includes providing a resin binder and basalt fibers, contacting the resin binder and the basalt fibers, and adding a solvent to the contacted resin binder and basalt fibers. The solvent, resin binder and basalt fibers are mixed to form a slurry, which is supplied to a headbox, and then transferred from the headbox onto a conveyer. While on the conveyer, a vacuum is applied to the slurry to form the web, and also to partially remove the solvent from the slurry.

The present disclosure also includes a roof lining for an automotive vehicle having a substrate having a front face and a back face, and a surface skin layer adhered to a front face of the substrate. The substrate is formed from a mixture of basalt fibers three-dimensionally intertwined with one another and a thermoplastic resin binder. The mixture of basalt fibers and a thermoplastic resin binder having been heated twice to a temperature sufficient to melt the thermoplastic resin binder.

To solve the problem of recycling the roof lining containing glass fibers, the presently disclosed roof lining containing basalt fibers mixed in a thermoplastic resin was developed.

### BRIEF DESCRIPTION OF THE DRAWINGS

The accompanying drawings, which are included to provide a further understanding of the present teachings and are incorporated in and constitute a part of this specification, illustrate various exemplars of the present teachings and together with the detailed description serve to explain the principles of the present teachings. In the drawings:

FIG. 1 is an external view showing a roof lining for a vehicle according to the present teachings;

FIG. 2 is a sectional view showing a configuration of the roof lining for a vehicle;

FIG. 3 is an enlarged sectional view showing relations among elements configuring the roof lining for a vehicle;

FIG. 4 is an explanatory diagram showing an overview of a manufacturing method of the roof lining for a vehicle according to the present teachings;

FIG. 5 is an explanatory diagram showing a lamination process of a web and a film for materials of the roof lining for a vehicle;

FIG. 6 is a diagram showing a cross section structure before heating of a substrate used for the roof lining for a vehicle;

FIG. 7 is an explanatory diagram showing a heating process in the manufacturing method of the roof lining for a vehicle according to the present teachings;

FIG. 8 is a diagram showing a heated and expanded state of the substrate of the roof lining for a vehicle according to the present teachings;

FIG. 9 is an explanatory diagram showing a setting step of the materials in the manufacturing method of the roof lining for a vehicle according to the present teachings;

FIG. 10 is an explanatory diagram showing a cold press forming step in the manufacturing method of the roof lining for a vehicle according to the present teachings;

FIG. 11 is a sectional view showing a configuration of a conventional roof lining for a vehicle; and

FIG. 12 is an explanatory diagram showing elements of a conventional roof lining for a vehicle.

### DETAILED DESCRIPTION OF THE PREFERRED EMBODIMENTS

The present teachings are directed to a method for producing a roof lining for a vehicle by forming a web comprising basalt fibers and a resin composition, and heating the web to a temperature sufficient to melt the resin composition. The web is then pressed into a blank having a first thickness. The blank is then heated to a temperature sufficient to melt the resin composition, and then press formed to form the roof lining.

Forming the web is itself a multi-step process involving providing a resin binder and basalt fibers, and contacting the resin binder and the basalt fibers. Then adding a solvent to the contacted resin binder and basalt fibers; although in some embodiments, all three components can be contacted together simultaneously. The solvent, resin binder and basalt fibers are mixed to form a slurry or mixture. The slurry is then supplied to a headbox. Suitable headboxes include, for instance, headboxes used by the papermaking industry to distribute paper pulp material onto a forming fabric or wire screen, and described, for instance, in U.S. Pat. Nos. 6,733,627 and 6,004,431. The slurry is then transferred from the headbox onto a conveyer where a vacuum is applied to the slurry on the conveyer to form the web. The vacuum partially removes the solvent from the slurry, and helps the web to form on the conveyer.

In the present method, water can be utilized as the solvent, and the resin binder can be in a powder form.

The present method can further include the step of contacting one side of the web with a first film and the other side of the web with a second film after heating the web. In some instances, the first film can be an air-impermeable film and the second film can be an adhesive film. The second film, especially an adhesive film, can be contacted with a surface skin layer after heating the blank and prior to or, in some embodiments, during press forming.

The pressing of the web in the present method results in a crushing of the basalt fibers, and a fixing of the basalt fibers in a biased direction in the resin composition. The pressing of the web can be accomplished by laminating the web by a nip roller, or other suitable rolling or compression apparatus.

The present method also includes cutting the blanks to the desired dimensions for the roof lining. This cutting step can occur after the web is pressed into a blank with a first thickness. Width cutters and length cutters, as utilized in continuous manufacturing processes, can be used in the presently disclosed method.

Upon heating the blank, the thickness of the blank changes from the first thickness, obtained after pressing the web into the blank, to a second thickness. The heating of the blank can be accomplished by using, for instance, an infrared oven to heat the blank to a temperature sufficient to melt the resin composition.

In some embodiments of the present method, the first thickness ranges between about 2 mm to about 4 mm, and the second thickness ranges between about 5 mm to about 7 mm. The increase in thickness upon the second heating is the result of the expansion or relaxation of the compressed basalt fibers forming spaces between fibers or forming air pockets within the blank after the blank is heated. The formation of the air pockets provides the heated blank with a second thickness, that can be, and in most embodiments is, different from and greater than the first thickness.

The press forming step of the present method can occur in a cold press forming die apparatus. In some instances, the resin composition can be allowed to substantially cool prior to press forming.

A roof lining for an automotive vehicle is also provided by the present teachings. The presently taught roof lining includes a substrate having a front face and a back face, and a surface skin layer adhered to a front face of the substrate. The substrate includes a mixture of basalt fibers three-dimensionally intertwined with one another and a thermoplastic resin binder. The mixture of basalt fibers and a thermoplastic resin binder is heated twice to a temperature sufficient to melt the thermoplastic resin binder.

In the roof lining according to the present teachings, the thermoplastic resin binder can be present in a concentration ranging from between about 20 and about 80 weight percent, and the basalt fibers can be present in a concentration ranging from between about 20 and about 80 weight percent.

The basalt fibers used in the present roof lining include fibers with an average diameter ranging from between about 10 microns to about 20 microns, and with an average length ranging from between about 20 microns to about 50 microns.

The present roof lining can also include an adhesive film located between the front face of the substrate and the surface skin layer. It can further include an air-impermeable film located on the back face of the substrate. The air-impermeable film can also have a back side located away from the substrate. A non-woven material can be located on the back side of the air-impermeable film in some exemplars of the present roof lining.

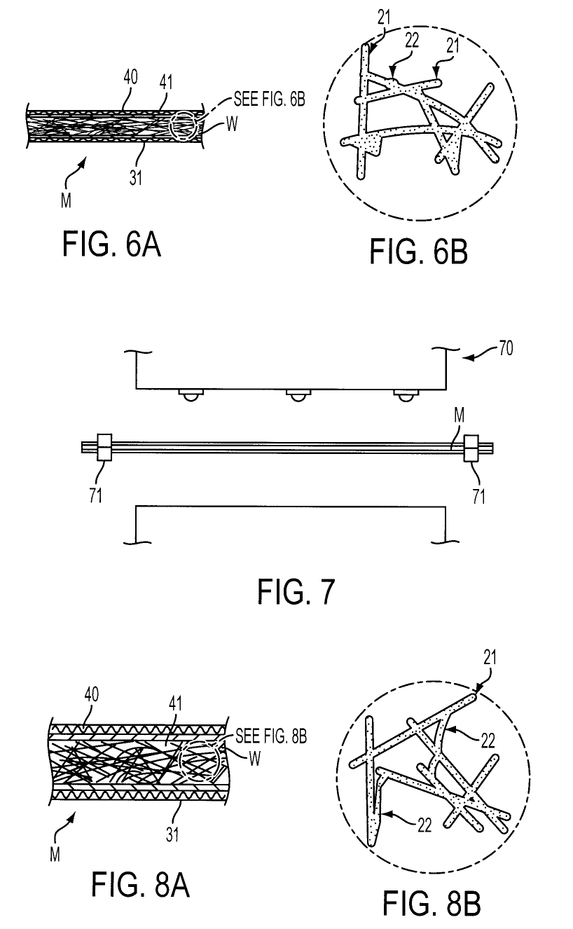

Within the substrate, the basalt fibers can be fixed by the thermoplastic resin binder in a state of being three-dimensionally intertwined with each other. A cross sectional structure of the substrate reveals that the basalt fibers are crushed and biased in a pressed down or fallen state, as shown in FIG. 6. The blank M has basalt fibers 21 fixed in the resin binder 22. In this particular state, the basalt fibers 21 are crushed and fixed in a flattened biased direction.

In various embodiments of the present teachings, the blank is reheated before forming the roof lining, and the resin binder melts. The melting of the resin binder allows the basalt fibers to rise and thus the blank expands. This reheating step is followed by a cold press process so that the basalt fibers can be maintained in the expanded state. The basalt fiber expanded state can result in an increased amount of air gaps and spaces between the basalt fibers intertwined and set inside the resin binder.

As shown in FIG. 8, upon heating, the resin binder 22 melts and any load previously applied to the basalt fibers 21 by the step of pressing the web into a blank is eliminated so that the basalt fibers 21 rise. The heated blank swells and the thickness of the blank M increases.

The dimensions of the basalt fibers can influence the properties of the roof lining, such as, sound absorbency, weight and stiffness. Additionally, the ratio between the basalt fibers and the binder thermoplastic resin can influence the properties of the roof lining, for example density. Basalt fiber dimensions and ratio between the fibers and the resin can be adjusted and selected according to not only the desired properties of the finished article but also the dimension and thickness of the finished article, shape of the roof lining and other factors. One of skill in the art will recognize the factors to be considered in making such selections.

The roof lining of the present teachings can also have an enhanced film or the like laminated on both sides of the blank for the purpose of reinforcing the stiffness. Additional embodiments can include an air-impermeable film laminated on the backside of the blank to prevent dust and the like from adhering to the front face side of the product, and a configuration in which a polyamide hot-melt film for enhancing adhesiveness to the surface skin layer or facing is attached.

A method of making paper from pulp can be adopted to the presently taught method of producing a roof lining. Initially, the basalt fibers and resin powder are separately provided to a mixing container. Water can be present in the mixing container, or added after addition of the basalt fibers and the resin powder. The three components can be mixed by stirring to form a slurry. The slurry can be supplied to a papermaking headbox, as described above.

The slurry can then be distributed by the headbox onto the conveyer. The conveyer can be made of a material that allows water to be removed while also capturing the resulting web of basalt fibers and resin powder, for instance, a wire-net belt or a fabric material. The moisture of the slurry can be removed by vacuum suction to form a web of the basalt fibers and resin powder. The web can then pass through a heating furnace to drive off more moisture and also to cause the resin powder to melt.

Films, such as, an air-impermeable film or an adhesive film, can be laminated by a nip roller onto one or both sides of the web. Passing through the nip roller results in the crushing of the web and the fixing of the basalt fibers in the resin binder. In some cases, the thickness of the web after passing through the nip roller can be about 3 mm. The web can become a hard or resilient sheet due to cooling and setting of the resin, which cooling can be enhanced by optional blowing of air across the web.

In the present method, in the web forming step, the basalt fibers can become biased in a fallen state by the force of either or both of the vacuum suction through the wire-net belt or the roll pressure of the nip roller, and can become fixed by the resin binder in that state. Thus, the basalt fibers, in this fixed fallen state, can have potential energy to return to a more expanded or relaxed state, and can return to that expanded state if released by the resin binder.

Further detailed description of the present teachings will be provided by referring to the drawings of some embodiments of a roof lining for a vehicle and a manufacturing method thereof.

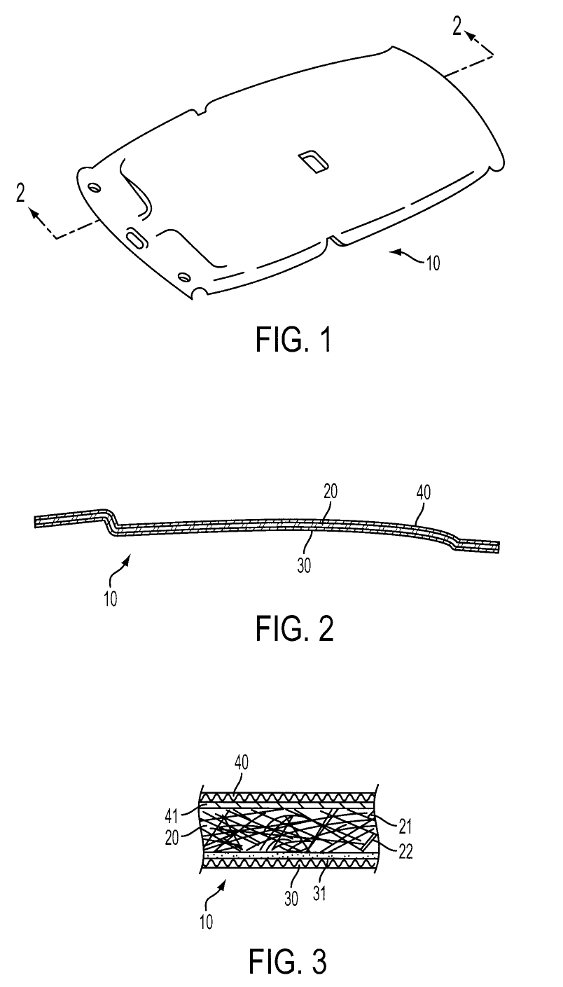

In FIGS. 1 to 3, a roof lining for a vehicle 10 has a surface skin layer 30 having pleasant tactile properties and appearance attached to a front face of a substrate 20 having shape retaining properties. On a backside of the substrate 20, there can be a laminated structure having a backside nonwoven fabric 40 provided for, in some embodiments, sound absorbency.

In some embodiments of the present roof lining, the substrate or blank 20 has a structure in which basalt fibers 21 are three-dimensionally intertwined and are fixed by a resin binder 22. This configuration can be lightweight, have enhanced sound absorbency and heat insulating properties while also having suitable stiffness. The surface skin layer 30 can be a relatively heavy weight material, such as 130 g/m2 in the case of using a cloth such as tricot, jersey, moquette or knit, and 200 g/m2 in the case of a nonwoven fabric. Additionally, a hot-melt film 31 for enhancing adhesiveness can be placed between the substrate 20 and the surface skin layer 30. The hot-melt film 31 can be laminated onto the substrate 20 during the production process, such as, during the pressing of the web into the blank.

According to the present teachings, suitable resins and resin mixtures that can be utilized in the process described above include propylene polymers, by which it is intended to include homopolymeric polypropylene and copolymers of propylene with other copolymerizable monomers wherein the major portion, that is, greater than about 50% by weight of the copolymer is comprised of propylene moieties. Suitable copolymerizable monomers include, for example, ethylene, butylene, 4-methyl-pentene-1, and the like.

The thermoplastic resins, for example, polypropylene resin, polystyrene resin, acrylonitrile-butadiene-styrene (ABS) resin and polycarbonate resin tend to have excellent characteristics such as the ability to be produced at comparatively low cost, and easy processability. According to the present teachings and among the above-exemplified resins and polymers, polypropylene resin is one preferred resin.

In one preferred embodiment of the present teachings, the surface skin layer 30 can be a tricot cloth of weight of about 130 g/m2 and a nylon film can be used as the hot-melt film 31. The backside nonwoven fabric 40 can have a relatively light weight ranging between about 10 to 100 g/m2, and an air-impermeable polyamide resin can be used as film 41 and can be placed between the backside nonwoven fabric 40 and the basalt fiber and resin binder containing substrate 20. As for the fiber of the backside nonwoven fabric 40, a general-purpose synthetic resin fiber such as polyolefin, polyester or polyamide can be used.

In some embodiments of the present teachings, the air-impermeable film 41 can be composed of a suitable material such as a thermoplastic film. Suitable thermoplastics include, for instance, polyolefins, polyethylene, polypropylene, polyamides, and ethylene-propylene copolymer films as acceptable film materials. The air-impermeable film 41 can be water-proof, or can be substantially water-proof, or can be substantially water-resistant.

The substrate 20 composed of the basalt fiber-containing material can be of substantially uniform density throughout, that is, the substrate does not have a higher density skin or coating on its outer surface.

The areal density of the substrate can be a factor in achieving the desired balance between weight and performance, such as sound absorbency and stiffness of the roof lining according to the present teachings. In some examples of the roof lining, it is desirable to have a substrate with an areal density ranging between about 600 to about 1200 g/m2. A concern in cases where the weight per square meters of the substrate is less than 600 g m2, can be that the stiffness of the part can be too low and handling can be difficult. Conversely, when the areal density of the substrate exceeds 1200 g/m2, curtain airbags which can be placed inside the roof lining can have difficulty in operating correctly. In some embodiments of the present roof lining, the areal density of the substrate 20 can be 900 g/m2 with a specific gravity of about 0.33.

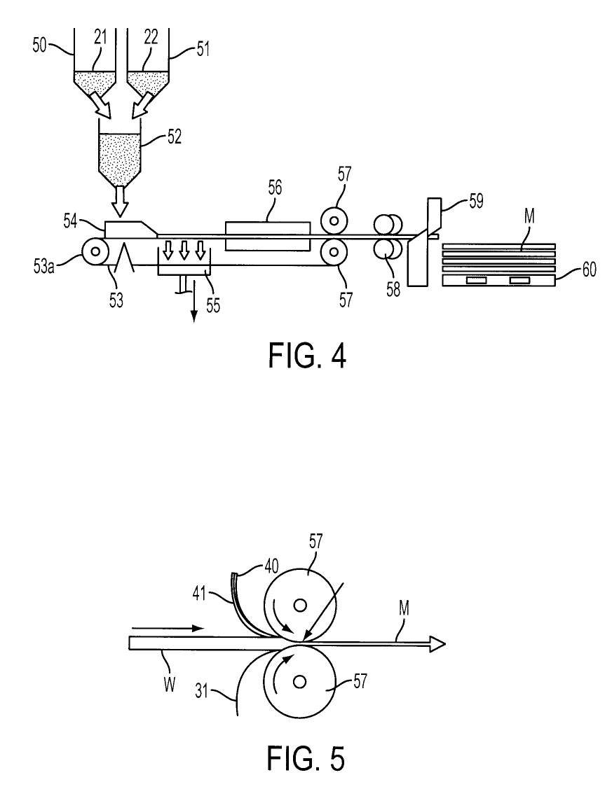

FIG. 4 illustrates one embodiment of the process of the present teachings. The basalt fibers 21 and the PP resin binder powder 22 are each contained in dedicated hoppers 50 and 51 respectively. The basalt fibers 21 and the PP resin binder powder 22 are transferred into a mixing container 52 from the hoppers 50 and 51. Water can be initially present in the mixing container 52, where the basalt fibers 21, the PP resin powder 22 and water are stirred to obtain a slurry. In some embodiments of the present process, water can be added to the mixing container 52 after one or both of the basalt fibers 21 and the PP resin powder 22 have been added to the mixing container 52.

A headbox 54 and the initial end of a wire-net belt conveyer 53 circulatively driven at a predetermined speed by a pulley 53a are positioned below the mixing container 52. The slurry is transferred from the mixing container 52 to the headbox 54. The slurry is then spread from the headbox 54 across the wire-net belt conveyer 53. A vacuum suction mechanism 55 positioned below the wire-net belt conveyer 53 removes water to form a web W consisting of the basalt fibers 21 and the PP resin powder 22. Any additional moisture remaining in the web W is evaporated by a heating furnace 56. The heating furnace 56 also causes the PP resin powder 22 to melt.

As shown in FIG. 5, an air-impermeable film 41 and a nonwoven fabric 40 are laminated by a nip roller 57 on the back face side of the web W to form a blank M. On the front face side of the web W, a hot-melt film 31 is laminated for later adhesion with a surface skin layer 30. The nip roller 57 crushes and adjusts the thickness of the blank to approximately 3 mm, and also fixes the basalt fibers 21 in the molten or softened PP resin binder 22.

The blank M is then cut to a predetermined size by a width cutter 58 and a length cutter 59, and piled on a palette 60. As shown in FIG. 6, the blank M in this state has the basalt fibers 21 fixed on the PP resin binder 22. In particular, this is the state where the basalt fibers 21 are fixed in a biased flattened direction.

As shown in FIG. 7, the blank M is heated and softened at a predetermined temperature by a suitable heating source, here, for example, an infrared heating furnace 70. In certain embodiments of the present teachings, the blank M is heated to the melting point temperature of the resin binder, such as, in the range of 170 to 230° C. As shown, the several of the edges of the blank M are held by clamps 71. In this heated condition, the resin binder 22 melts and the pressure previously applied to the basalt fibers 21 by the nip rollers 57 is eliminated so that the basalt fibers 21 rise and are restored as shown in FIG. 8.

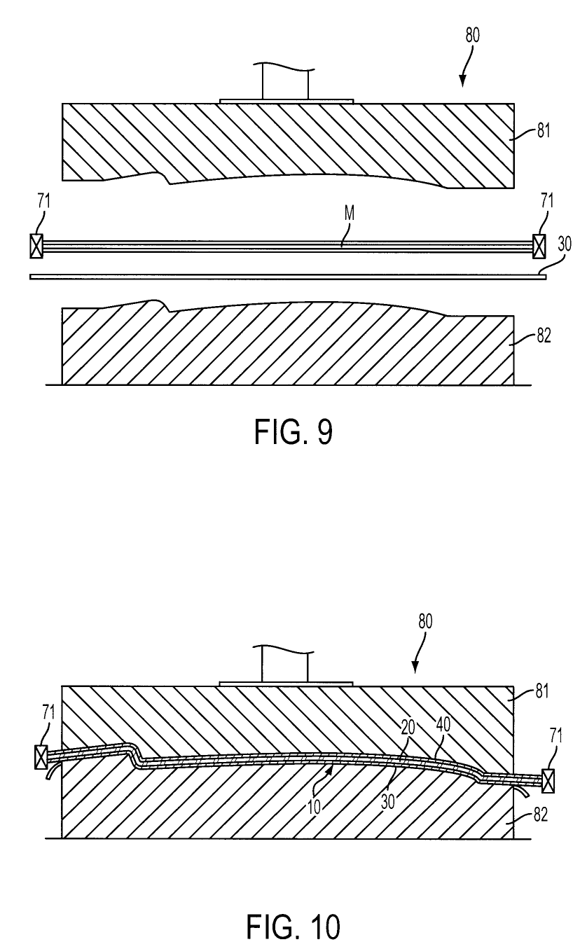

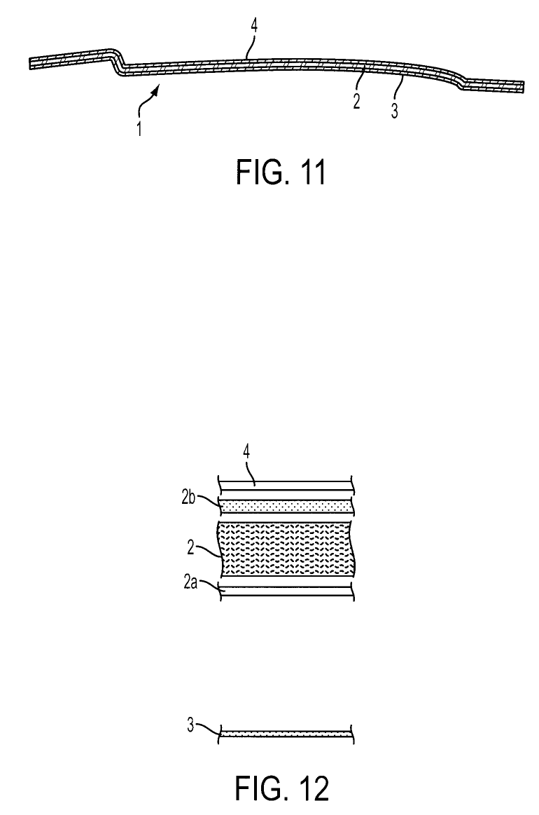

As shown in FIG. 9, the blank M, with any adhesive film facing toward the surface skin layer 30, and the surface skin layer 30 are aligned and set in a cold press forming die assembly 80 which consists of upper die 81 and lower die 82. Thereafter, as shown in FIG. 10, the upper die 81 is lowered by a predetermined stroke so as to form the substrate 20 having a form matching with the roof panel by clamping of the upper die 81 and lower die 82, and also to adhere the surface skin layer 30 to the substrate 20. In some embodiments of the process, one or both or the upper and lower dies can be moved to form the substrate 20. For various embodiments of the present roof lining, the roof lining is formed into the desired shape by the die assembly, with clamping forces of 50 ton and a press pressure of 1 to 3 kg/cm2. The cold press is then opened, and the formed roof lining is removed. The roof lining can undergo further processing to produce a final roof lining for a vehicle 10 as shown in FIG. 1.

All publications, articles, papers, patents, patent publications, and other references cited herein are hereby incorporated herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A method for producing a roof lining for a vehicle comprising:
forming a web comprising basalt fibers and a resin composition;
heating the web to a temperature sufficient to melt the resin composition;
pressing the web into a blank with a first thickness;
heating the blank to a temperature sufficient to melt the resin composition, and
press forming the blank to form the roof lining.

2. The method according to claim 1, wherein forming a web further comprises
providing a resin binder and basalt fibers;
contacting the resin binder and the basalt fibers;
adding a solvent to the contacted resin binder and basalt fibers;
mixing the solvent, resin binder and basalt fibers to form a slurry;
supplying the slurry to a headbox;
transferring the slurry from the headbox onto a conveyer, and
applying a vacuum to the slurry on the conveyer to form the web, wherein the vacuum partially removes the solvent from the slurry.

3. The method according to claim 2, wherein the solvent comprises water.

4. The method according to claim 2, wherein the resin binder comprises a powder.

5. The method according to claim 1, further comprising
contacting one side of the web with a first film and the other side of the web with a second film after heating the web.

6. The method according to claim 5, wherein the first film comprises an air-impermeable film and the second film comprises an adhesive film.

7. The method according to claim 5, further comprising
contacting the second film with a surface skin layer after heating the blank and prior to press forming.

8. The method according to claim 1, further comprising
cutting the blanks to desired dimensions for the roof lining.

9. The method according to claim 1, wherein upon heating the blank the thickness of the blank changes from the first thickness to a second thickness.

10. The method according to claim 9, wherein the first thickness ranges between about 2 mm to about 4 mm, and the second thickness ranges between about 5 mm to about 7 mm.

11. The method according to claim 1, wherein the press forming occurs in a cold press forming die apparatus.

12. The method according to claim 1, wherein the resin composition is allowed to substantially cool prior to press forming.

13. The method according to claim 1, further comprising
forming air pockets within the blank after the blank is heated whereby the heated blank has a second thickness, and
wherein the second thickness is greater than the first thickness.

14. The method according to claim 1, wherein pressing of the web further comprises
crushing the basalt fibers, and
fixing the fibers in a biased direction in the resin composition.

15. The method according to claim 1, wherein the pressing of the web comprises
laminating the web by a nip roller.

16. A roof lining for an automotive vehicle comprising:
a substrate having a front face and a back face, and
a surface skin layer,
wherein the substrate comprises a mixture of basalt fibers three-dimensionally intertwined with one another and a thermoplastic resin binder,
the mixture of basalt fibers and a thermoplastic resin binder having been heated twice to a temperature sufficient to melt the thermoplastic resin binder, and
the surface skin layer is adhered to a front face of the substrate.

17. The roof lining according to claim 16, wherein the thermoplastic resin binder is present in a concentration ranging from between about 20 and about 80 weight percent, and the basalt fibers are present in a concentration ranging from between about 20 and about 80 weight percent.

18. The roof lining according to claim 16, wherein the basalt fibers comprise fibers with an average diameter ranging from between about 10 microns to about 20 microns.

19. The roof lining according to claim 16, wherein the basalt fibers comprise fibers with an average length ranging from between about 20 microns to about 50 microns.

20. The roof lining according to claim 16, further comprising an adhesive film located between the front face of the substrate and the surface skin layer.

21. The roof lining according to claim 16, further comprising an air-impermeable film positioned on the back face of the substrate, and
wherein the air-impermeable film has a back side located opposite the substrate.

22. The roof lining according to claim 21, further comprising a non-woven material positioned on the back side of the air-impermeable film.
